(19) United States
(12) Patent Application Publication
(10) Pub. No.: US 2022/0182378 A1
(43) Pub. Date: Jun. 9, 2022

(54) Biometric Verification Service

(71) Applicant: Arvind Singh, Edmond, OK (US)

(72) Inventor: Arvind Singh, Edmond, OK (US)

(21) Appl. No.: 17/247,258

(22) Filed: Dec. 5, 2020

(51) Int. Cl. H04L 29/06; H04L 29/08

(52) U.S. Cl. CPC H04L 63/0861; H04L 67/18

(57) ABSTRACT

The Biometric Verification System is a software application for verifying the current personal identity and/or current geographic location of an user of an identity secured electronic system by enabling a software event triggered real-time biometric identity validation or geographic location validation to enable the validation/re-validation of an user's identity and/or location and issue a security alert notice and notice of a failed biometric identity validation and/or geographic location to said identity secured electronic system to enable validation/re-validation or prevent a transaction from occurring by said identity secured electronic system whenever said biometric identity validation fails to validate/re-validate said user's identity. Alerts, conditions, and parameters for software event triggers can be set to control monetary amounts and limits, electronic system features, functions, and interface limits/restrictions.

### TECHNICAL FIELD OF THE INVENTION

This invention relates generally to a Biometric Verification Service in the form of a software application for the purpose of enabling biometric (to include, but not be limited to, any combination of fingerprint, photo, retina, voice, and location data) identity validation/re-validation, verification/re-verification during an online multi-step secured identity (and/or secured connection) electronic transactions with electronic systems (to include, but not be limited to, applications, networked computers/systems, websites, databases, user interfaces, and/or online systems) in order to further ensure, validate/re-validate, verify/re-verify user identity.

This invention relates specifically to a Biometric Verification Service in the form of a software application for the purpose of enabling biometric identity validation/re-validation, verification/re-verification online, live-time transacted service while using (during the operation of) and interacting with an electronic system using a multi-step secured identity sequence to verify user identity in order to authorize transacting with said electronic system in order to further ensure, validate/re-validate, verify/re-verify user identity at pre-set times, upon demand, and/or within predetermined operational and functional limits based on the electronic system in use.

### BACKGROUND

In today's electronic application based world, the need to secure or verify a user's identity has become important, and even essential at times, when valuable business and personal transactions are conducted online. There are a multitude of password, question-answer challenge, twostep verification systems with two devices or combinations of password, and passcode verification issued at the time of login, private code/key encrypted, applications, systems, websites, databases, cloud services, user interfaces, and/or online systems methods to verify a user's identity prior to granting access to interact with an electronic system. There are some electronic systems which have features to further authorize certain or special transactions or interactions within that electronic system itself for some kinds of transactions or interactions as determined by the vendor/operator of that electronic system.

What is not present in the art today, is a software application for the purpose of enabling biometric identity validation/re-validation, verification/re-verification online, live-time transacted service while using and interacting with an electronic system once verified by identity in order to authorize continuing to transact with said electronic system in order to further ensure, validate/re-validate, verify/re-verify user identity at pre-set times, upon demand, and/or within predetermined operational and functional limits based on the electronic system in use within parameters determined by the operator not the vendor/operator of any electronic system.

In light of the foregoing art, there is a need for a software application for the purpose of enabling biometric identity validation/re-validation, verification/re-verification during online, live-time transacted services while using and interacting with an electronic system with user identity validation/verification in order to authorize continuing to transact with said electronic system in order to further ensure, validate/re-validate, verify/re-verify user identity at pre-set times, upon demand, and/or within predetermined operational and functional limits based on the electronic system in use within parameters determined by the operator/user.

### BRIEF SUMMARY OF THE INVENTION

According to a first aspect of the invention, there is a Biometric Verification Service comprising software application/system for verifying a personal identity of an user of an identity secured electronic system comprising software enabling a software event triggered real-time biometric identity validation to enable the validation/re-validation of said user's personal identity during said user's use of said identity secured electronic system enabling a validation/re-validation software event during said user's use of said identity secured electronic system to verify an identity of said user and the issue of a security alert notice and notice of a failed biometric identity validation to said identity secured electronic system to enable re-validation by said identity secured electronic system whenever said biometric identity validation fails to validate/re-validate said user's personal identity.

According to a second aspect of the invention, there is a Biometric Verification Service further comprising a software application/system enabling a determination of a cash transaction amount software event trigger requiring biometric identity validation during said user's use of an electronic system.

According to a third aspect of the invention, there is a Biometric Verification Service further comprising a software application/system enabling a determination of an application interaction software event trigger requiring biometric identity validation for an interaction by said user's use of an electronic system.

According to a fourth aspect of the invention, there is a Biometric Verification Service further comprising a software application/system enabling a determination of a geographic location software event trigger requiring biometric identity validation an during said user's use of an electronic system.

According to a fifth aspect of the invention, there is a Biometric Verification Service further comprising a software application/system enabling a determination of a cash transaction amount software event trigger requiring biometric identity validation during said user's use of an electronic system, and software enabling a determination of an application interaction software event trigger requiring biometric identity validation for an interaction by said user's use of an electronic system.

According to a sixth aspect of the invention, there is a Biometric Verification Service further comprising a software application/system enabling a determination of a cash transaction amount software event trigger requiring biometric identity validation during said user's use of an electronic system, and software enabling a determination of a geographic location software event trigger requiring biometric identity validation an during said user's use of an electronic system.

According to a seventh aspect of the invention, there is a Biometric Verification Service further comprising a software application/system enabling a determination of a cash transaction amount software event trigger requiring biometric identity validation during said user's use of an electronic system, and software enabling a determination of an application interaction software event trigger requiring biometric identity validation for an interaction by said user's use of an electronic system, and software enabling a determination of a geographic location software event trigger requiring biometric identity validation an during said user's use of an electronic system.

According to an eighth aspect of the invention, there is a software Biometric Verification Application/System for verifying a personal identity of an user of an identity secured electronic system comprising software enabling a software event triggered real-time biometric identity validation to enable the validation/re-validation of said user's personal identity during said user's use of said identity secured electronic system enabling a validation/re-validation software event during said user's use of said identity secured electronic system to verify an identity of said user and the issue of a security alert notice and notice of a failed biometric identity validation to said identity secured electronic system to enable re-validation by said identity secured electronic system whenever said biometric identity validation fails to validate/re-validate said user's personal identity, further comprising software enabling a current geographic location of a user to be validated/re-validated using a current geographic location of said user and the issue of a security alert notice and notice of a failed current geographic location validation to said identity secured electronic system to enable re-validation by said identity secured electronic system whenever said current geographic location validation fails to validate/re-validate said user's current geographic location.

According to a ninth aspect of the invention, there is a Biometric Verification Service as in the eighth aspect, further comprising a software application/system enabling a determination of a cash transaction amount software event trigger requiring biometric identity validation during said user's use of an electronic system.

According to a tenth aspect of the invention, there is a Biometric Verification Service as in the eighth aspect, further comprising a software application/system enabling a determination of an application interaction software event trigger requiring biometric identity validation for an interaction by said user's use of an electronic system.

According to an eleventh aspect of the invention, there is a Biometric Verification Service further as in the eighth aspect, comprising a software application/system enabling a determination of a geographic location software event trigger requiring biometric identity validation during said user's use of an electronic system.

According to a twelfth aspect of the invention, there is a Biometric Verification Service as in the eighth aspect, further comprising a software application/system enabling a determination of a cash transaction amount software event trigger requiring biometric identity validation during said user's use of an electronic system, and software enabling a determination of an application interaction software event trigger requiring biometric identity validation for an interaction by said user's use of an electronic system.

According to a thirteenth aspect of the invention, there is a Biometric Verification Service as in the eighth aspect, further comprising a software application/system enabling a determination of a cash transaction amount software event trigger requiring biometric identity validation during said user's use of an electronic system, and software enabling a determination of a geographic location software event trigger requiring biometric identity validation during said user's use of an electronic system.

According to a fourteenth aspect of the invention, there is a Biometric Verification Service as in the eighth aspect, further comprising a software application/system enabling a determination of a cash transaction amount software event trigger requiring biometric identity validation during said user's use of an electronic system, and software enabling a determination of an application interaction software event trigger requiring biometric identity validation for an interaction by said user's use of an electronic system, and software enabling a determination of a geographic location software event trigger requiring biometric identity validation during said user's use of an electronic system.

According to a fifteenth aspect of the present invention there is a Biometric Verification Service in the form of a software application for the purpose of enabling a biometric identity validation/re-validation, verification/re-verification online in a live-time transacted service while using and interacting with an user identity secured electronic system in order to further ensure, validate/re-validate, verify/re-verify user identity at pre-set times, upon demand, and/or within predetermined operational and functional limits based on the user identity secured electronic system in use by said user.

An advantage of enabling a biometric identity validation/re-validation, verification/re-verification online with a live-time transacted service while using and interacting with an electronic system is the ability to enable user control and limits of interaction. Further an advantage of enabling a real-time biometric identity validation/re-validation, verification/re-verification service online while a user is using and interacting with an electronic system is the ability to disable/disapprove secured transactions when a user's device has been hacked or stolen during or after securely logging in with their identity to prevent theft and report electronic data regarding the hacker and/or thief.

The invention will now be described, by way of example only, with reference to the accompanying drawings in which:

### BRIEF DESCRIPTION OF THE DRAWINGS

FIG. 1 is a flowchart view of the process flow according to the invention.

### DETAILED DESCRIPTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etcetera indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

With regard to determining what is intended by the word “use” as it relates to a user's “use” of an electronic system, the word “use” is intended to include at least, but not be limited to, the operation, interaction, transaction of an electronic system by a user when using said electronic system. In other words, “use” as it relates to a user's “use” of an electronic system is intended to collectively apply to and include all manner of user interaction with said electronic system. With regard to determining what is intended by the phrases “biometric” and “biometric identity” as it relates to personal information useable to verify a user's identity, “biometric” and “biometric identity” include, but are not to be limited to, any combination of fingerprint, photo, retina, voice, and location data that can be used to conduct a comparison and verify/validate an identity.

With regard to determining what is intended by the phrase “electronic system” as it relates to or is an application that a user accesses, it typically involves a user identity verified process to enable interaction with (use of) the electronic system by a user. Further, an electronic system can be, but is not limited to, software applications, networked computers/systems, websites, applications on/from websites, databases, cloud services, user interfaces, and/or online systems.

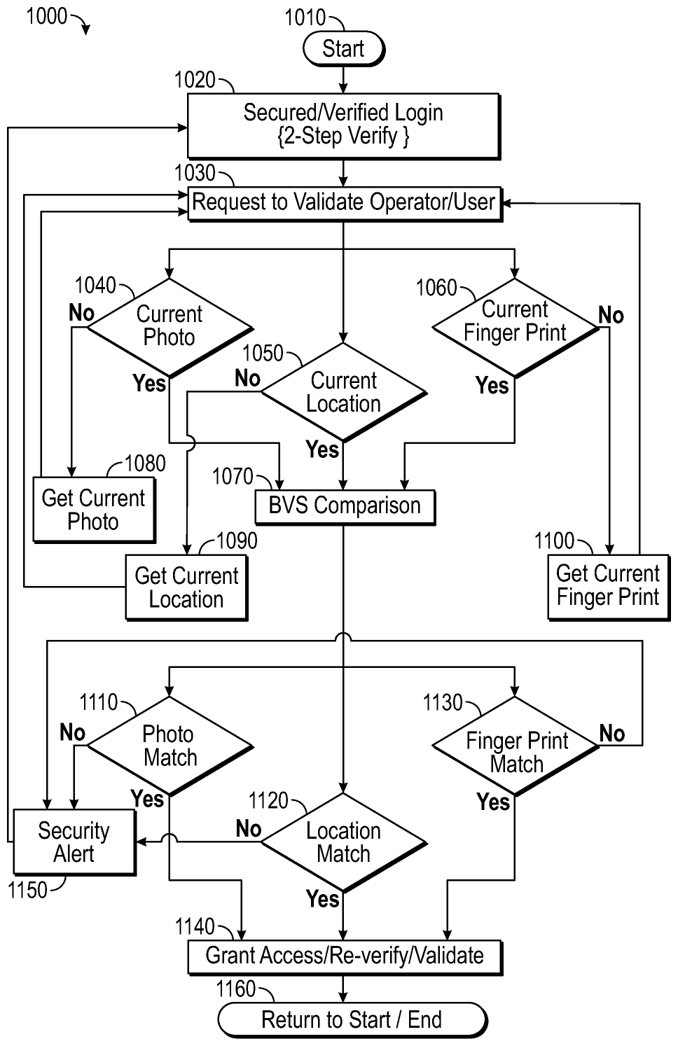

Referring to the FIGURE, there is shown in FIG. 1, Element 1000 which is the process flow diagram according to the present invention.

Index of Labelled Features in FIG. 1, with Description, and in numeric order:

Element 1010, “Start,” is the Start of the process flow.

Element 1020, “Secured/Verified Login {2-Step Verify},” is the operation or function of opening and verifying a user's identity to commence the user's interaction with

Element 1030, “Request to Validate Operator/User,” is the software event triggered to request a biometric or location verification.

Element 1040, “Current Photo,” is the decision in the process flow wherein a determination is made as to whether there is a current, instant, or taken-by-surprise photo of the operator/user available for comparison to a known standard for verification. When there is not a current, instant, or taken-by-surprise photo of the operator/user available, the flow passes to Element 1080 below to obtain a current photo for comparison. When there is a current, instant, or taken-by-surprise photo of the operator/user available, the flow passes on to Element 1070 for the comparison and issue of validation or non-validation notices.

Element 1050, “Current Location,” is the decision in the process flow wherein a determination is made as to whether there is a current, instant, or taken-by-surprise location of the operator/user available for comparison to a known standard for verification. When there is not a current, instant, or taken-by-surprise location of the operator/user available, the flow passes to Element 1090 below to obtain a current location for comparison. When there is a current, instant, or taken-by-surprise location of the operator/user available the flow passes on to Element 1070 for the comparison and issue of validation or non-validation notices.

Element 1060, “Current Finger Print,” is the decision in the process flow wherein a determination is made as to whether there is a current, instant, or taken-by-surprise finger print of the operator/user available for comparison to a known standard for verification. When there is not a current, instant, or taken-by-surprise finger print of the operator/user available the flow passes to Element 1100 below to obtain a current finger print for comparison. When there is a current, instant, or taken-by-surprise finger print of the operator/user available the flow passes on to Element 1070 for the comparison and issue of validation or non-validation notices.

Element 1070, “BVS Comparison,” is the function in the process wherein a current, instant, or taken-by-surprise biometric data package, to include, but not be limited to, a photo, geographic location, and/or finger print is compared to a known quality standard or data set that was previously entered, saved, or uploaded as current and valid.

Element 1080, “Get Current Photo,” is the function in the process wherein a current, instant, or taken-by-surprise photo is obtained for use in validation/re-validation. Once a current photo is obtained, flow passes back up to Element 1020, “Secured/Verified Login {2-Step Verify}.”

Element 1090, “Get Current Location,” is the function in the process wherein a current, instant, or taken-by-surprise location is obtained for use in validation/re-validation. Once a current location is obtained, flow passes back up to Element 1020, “Secured/Verified Login {2-Step Verify}.”

Element 1100, “Get Current Finger Print,” is the function in the process wherein a current, instant, or taken-by-surprise finger print is obtained for use in validation/re-validation. Once a current finger print is obtained, flow passes back up to Element 1020, “Secured/Verified Login {2-Step Verify}.”

Element 1110, “Photo Match,” is the decision in the process flow wherein a determination is made as to whether the current, instant, or taken-by-surprise photo of the operator/user compared is a match. When the photo is a match, flow passes to Element 1140 below to grant access, verify/re-verify, and/or validate/re-validate the user's identity and continue without interruption either ending the flow, or returning to the start again to wait for another request to validate the operator/user (1030), When the photo is not a match, flow passes to Element 1150 to issue alarm and security notices.

Element 1120, “Location Match,” is the decision in the process flow wherein a determination is made as to whether the current, instant, or taken-by-surprise location of the operator/user compared is a match. When the location is a match, flow passes to Element 1140 below to grant access, verify/re-verify, and/or validate/re-validate the user's identity and continue without interruption either ending the flow, or returning to the start again to wait for another request to validate the operator/user (1030), When the location is not a match, flow passes to Element 1150 to issue alarm and security notices.

Element 1130, “Finger Print Match,” is the decision in the process flow wherein a determination is made as to whether the current, instant, or taken-by-surprise location of the operator/user compared is a match. When the finger print is a match, flow passes to Element 1140 to grant access, verify/re-verify, and/or validate/re-validate the user's identity and continue without interruption either ending the flow, or returning to the start again to wait for another request to validate the operator/user (1030). When the finger print is not a match, flow passes to Element 1150 to issue alarm and security notices.

Element 1140, “Grant Access/Re-verify/Validate,” is the function in the process wherein access is granted, verified/re-verified, validated/re-validated as a result of a successful match of any one, or any combination of photo, location, finger print, or any other biometric data element/set sent as a result of the request to validate (1030).

Element 1150, “Security Alert,” is the function in the process wherein notices are sent to the device in use and the user identity verified electronic system is noticed that the user it verified is no longer the current user. These notices can include, but are not limited to, any hacker or electronic thief data, or electronic information available via their electronic/networked connection.

Element 1160, “Return to Start/End,” is the end the process and/or return to a waiting state, awaiting a request to validate an operator/user (1030).

In an embodiment of the invention, there is a Biometric Verification Service comprising software application/system for verifying a personal identity of an user of an identity secured electronic system comprising software enabling a software event triggered real-time biometric identity validation to enable the validation/re-validation of said user's personal identity during said user's use of said identity secured electronic system enabling a validation/re-validation software event during said user's use of said identity secured electronic system to verify an identity of said user and the issue of a security alert notice and notice of a failed biometric identity validation to said identity secured electronic system to enable re-validation by said identity secured electronic system whenever said biometric identity validation fails to validate/re-validate said user's personal identity.

In an embodiment of the invention, there is a Biometric Verification Service further comprising a software application/system enabling a determination of a cash transaction amount software event trigger requiring biometric identity validation during said user's use of an electronic system. The cash transaction amount software event trigger can be set based on a total cash approval amount that applies across all electronic systems that are used in conjunction with the present invention, or can be used and applied to only one electronic system, or even a single login to a single electronic system.

In an embodiment of the invention, there is a Biometric Verification Service further comprising a software application/system enabling a determination of an application interaction software event trigger requiring biometric identity validation for an interaction by said user's use of an electronic system. An application interaction software event trigger can be, but is not limited to, any user interaction or user controllable setting within any electronic system a user accesses and uses. Application interaction software event triggers can be set across electronic systems so as to apply to all of a user's electronic systems and/or any subset of electronic systems or even single login events/sessions to electronic systems.

In an embodiment of the invention, there is a Biometric Verification Service further comprising a software application/system enabling a determination of a geographic location software event trigger requiring biometric identity validation during said user's use of an electronic system. Geographic location determination can be made based on, but not limited to, a specific location and/or a range of any distance or shape in and around a geographic location.

In an embodiment of the invention, there is a Biometric Verification Service further comprising a software application/system enabling a determination of a cash transaction amount software event trigger requiring biometric identity validation during said user's use of an electronic system, and software enabling a determination of an application interaction software event trigger requiring biometric identity validation for an interaction by said user's use of an electronic system.

In an embodiment of the invention, there is a Biometric Verification Service further comprising a software application/system enabling a determination of a cash transaction amount software event trigger requiring biometric identity validation during said user's use of an electronic system, and software enabling a determination of a geographic location software event trigger requiring biometric identity validation during said user's use of an electronic system.

In an embodiment of the invention, there is a Biometric Verification Service further comprising a software application/system enabling a determination of a cash transaction amount software event trigger requiring biometric identity validation during said user's use of an electronic system, and software enabling a determination of an application interaction software event trigger requiring biometric identity validation for an interaction by said user's use of an electronic system, and software enabling a determination of a geographic location software event trigger requiring biometric identity validation during said user's use of an electronic system.

In a preferred embodiment of the invention, there is a software Biometric Verification Application/System for verifying a personal identity of an user of an identity secured electronic system comprising software enabling a software event triggered real-time biometric identity validation to enable the validation/re-validation of said user's personal identity during said user's use of said identity secured electronic system enabling a validation/re-validation software event during said user's use of said identity secured electronic system to verify an identity of said user and the issue of a security alert notice and notice of a failed biometric identity validation to said identity secured electronic system to enable re-validation by said identity secured electronic system whenever said biometric identity validation fails to validate/re-validate said user's personal identity, further comprising software enabling a current geographic location of a user to be validated/re-validated using a current geographic location of said user and the issue of a security alert notice and notice of a failed current geographic location validation to said identity secured electronic system to enable re-validation by said identity secured electronic system whenever said current geographic location validation fails to validate/re-validate said user's current geographic location.

In a preferred embodiment of the invention, there is a Biometric Verification Service further comprising a software application/system enabling a determination of a cash transaction amount software event trigger requiring biometric identity validation during said user's use of an electronic system.

In a preferred embodiment of the invention, there is a Biometric Verification Service further comprising a software application/system enabling a determination of an application interaction software event trigger requiring biometric identity validation for an interaction by said user's use of an electronic system.

In a preferred embodiment of the invention, there is a Biometric Verification Service further comprising a software application/system enabling a determination of a geographic location software event trigger requiring biometric identity validation during said user's use of an electronic system.

In a preferred embodiment of the invention, there is a Biometric Verification Service further comprising a software application/system enabling a determination of a cash transaction amount software event trigger requiring biometric identity validation during said user's use of an electronic system, and software enabling a determination of an application interaction software event trigger requiring biometric identity validation for an interaction by said user's use of an electronic system.

In a preferred embodiment of the invention, there is a Biometric Verification Service further comprising a software application/system enabling a determination of a cash transaction amount software event trigger requiring biometric identity validation during said user's use of an electronic system, and software enabling a determination of a geographic location software event trigger requiring biometric identity validation during said user's use of an electronic system.

In a preferred embodiment of the invention, there is a Biometric Verification Service further comprising a software application/system enabling a determination of a cash transaction amount software event trigger requiring biometric identity validation during said user's use of an electronic system, and software enabling a determination of an application interaction software event trigger requiring biometric identity validation for an interaction by said user's use of an electronic system, and software enabling a determination of a geographic location software event trigger requiring biometric identity validation during said user's use of an electronic system.

In a preferred embodiment of the present invention, there is a Biometric Verification Service in the form of a software application for the purpose of enabling a biometric identity validation/re-validation, verification/re-verification online in a live-time transacted service while using and interacting with an user identity secured electronic system in order to further ensure, validate/re-validate, verify/re-verify user identity at pre-set times, upon demand, and/or within predetermined operational and functional limits based on the user identity secured electronic system in use by said user.

An advantage of enabling a biometric identity validation/re-validation, verification/re-verification online with a live-time transacted service while using and interacting with an electronic system is the ability to enable user control and limits of interaction. User's can set transaction amounts, geographic limits/ranges, even frequency and duration of sessions with and for when the user is using any number and combination of identity verified electronic systems and other electronic systems to be accessed by the user wherein a further validation/re-validation, verification/re-verification is desired, and/or wherein a user wants to limit or control the features and functions of electronic systems they access, and/or where a user wants to allow another use of their login to an electronic system for a time, duration, location, or range of locations.

Further, an advantage of enabling a real-time biometric identity validation/re-validation, verification/re-verification service online while a user is using and interacting with an electronic system is the ability to disable/disapprove secured transactions when a user's device has been hacked or stolen during or after securely logging in with their identity to prevent theft and report electronic data regarding the hacker and/or thief. While engaged in place of a verified user, a hacker or thief may have photo, location, and/or finger print data taken as scheduled or as a surprise event if the system of the present invention detects possible inappropriate activity. Any and all data collected regarding a hacker or thief can be uploaded to an electronic online data storage service in addition to being saved and stored on the device/apparatus that it was acquired upon.

Further advantages of the present invention include the electronic capability to set a predetermined or interactive geographic location, or geographic location range within which to enable validation/re-validation, verification/re-verification. This enables at least, but not limited to, verification by geographic location or area as determined by a plurality of locations and ranges from said location. Geographic location data can be derived from, but is not limited to, geographic and location data from cameras, global positioning systems, and data embedded into and/or as a part of a data file such as, but not limited to, an image or video file.

Further advantages of the present invention include addressing solutions for e-commerce and government web applications. For example, an unidentified intruder tries to steal cookies and tries to establish an SSL connection to steal a user's identity and/or information, in such cases the present invention gives vital intelligence in the form of the data the present system collects regarding the intruder and it can send alerts to user's and any connected persons or systems with the present invention installed and active on their end of the interaction. In cases where the intruder may choose not to send biometric data in such cases the present invention can ingest spyware and capture data later with no knowledge of the intruder. This makes intruders traceable during attempted break-ins. This helps secure sensitive data. Intruders would fear to even attempted break-in to a secured application when the present invention is monitoring.

Further advantages of the present invention include that it performs capturing biometric, photo, fingerprint, locations, and application data from a secured electronic system, at the time the system of the present application is enabled. This enables the advantage of user security (validation/re-validation, verification/re-verification) in cases where secured data access control requires and/or includes that a user be physically present (in person) but such user security was not a part of the initial interaction and/or connection with said user. This can be done for example, but not limited to, using the present invention either in person, by phone, or during a live online application session.

Further advantages of the present invention include use cases where a user is required to be physically present in a particular place in order to access or use a system, building location or feature. For example, in applications and systems using location based access controls, the present invention supports location based networks, access control areas, and specified geographic areas of access to enable securing sensitive applications and/or systems on a particular site or location by using the present invention to verify/validate prior to granting access, and/or continuing to ensure the physical presence on the network or in the control area. In other words, the present invention supports enabling the validation/re-validation, verification/re-verification of user's on or at a specified location based network, access control area, or defined geographic area.

Further advantages of the present invention include use cases where user identity is desired and/or required in order to use some electronic system's application data. For example, in applications and systems that do not currently have user identity verification/validation, the present invention enables securing sensitive application data prior to granting access, and/or continuing to grant access. In other words, the present invention supports enabling the validation/revalidation, verification/re-verification of user's identity on an electronic system or application that does not include such intrinsic functioning.

The following are few example biometric verification solutions (use cases) of a Biometric Verification Services [BVS] as embodied by the present invention. There are other biometric security solutions and use cases for BVS, biometric security solutions and uses are not limited to following examples.

Example BVS Solution for e-commerce applications: One of the biggest threats for digital security is user session data which can be easily compromised. Session data can be username and password for authenticating user into sensitive applications like banking systems and e-commerce online shopping websites where users financial information/data is stored and thus can be compromised. The BVS solution resolves the authentication and authorization issues using physical biometrics taken from an internet/network connected device, like a smartphone, at run time when a user validates their identity using real time biometric data captured with said internet/network connected device.

In an alternate embodied solution, there is an e-commerce website integrated with a BVS service. The login event on landing web page triggers biometric scan of the user requesting an access to critical application. The BVS app installed on the users internet/network connected hand held device will take current photo, retina scan (optional), geographic location and fingerprint of user and submit same for authentication. The real time biometric data is then verified against prior registered data in the BVS database.

In an alternate embodied solution, the BVS can also be used in a banking system e-commerce app using credit card information, or a banking system wiring money. The biometric data of a person, for example a photo, fingerprint, location, and/or retina scan/image can be stored in the banking system database and can be used for verification purposes for authenticating bank transaction at run time. The user can enable/disable a biometric shield using a BVS application installed on an internet/network connected device. The user will have ability to enable/disable the biometric verification. Also, the user can set transaction amount limits that need to be run through biometric verification.

In an alternate embodied solution, a user can set an authentication trigger for any transaction amount greater than $500 to be authenticated through the BVS. Once this biometric shield is enabled no one other than that user can approve such a transaction. For instance, lets say user has enabled a BVS biometric shield for credit card transactions and then later some malicious actor tries to use stolen credit card on a e-commerce website, the real user will get alert from the BVS app to approve a transaction, and the user will realize that it is a fraudulent transaction. The user can reject the transaction and hence avoid financial losses.

In a preferred embodiment of the BVS system, the software further comprises computer automated intelligence to capture fraudulent user locations, for example from location data in photos. If user is valid then during transaction event will be sent to users BVS iPhone app to take live photo and finger-print and will be verified against database to approve bank transaction.

Example BVS Solution for election voting system: An electronic voting system is an important system and needs to be 100% protected. In an embodiment of the present invention there is a “citizen database” which could have all the information of registered voters captured ahead of time and duly verified and certified by an election board. Then voters can download a BVS election version of the BVS application and then verify their biometrics, and upon a successful BVS verification a voter can cast a ballet.

Example BVS Solution for protecting payroll applications: There is an alternate embodiment of the present invention for the many corporations across the globe that have the huge burden of securing payroll and human resources management applications. Systems and operators running payroll and human resources management applications to pay employees have access to cash rich bank accounts and any fraudulent attacks on corporate payroll systems must be protected and secured. The BVS system can be integrated into these payroll and human resources management applications via Automated Programming Interface (API) calls to authenticate the person authorizing a payroll process in a production environment. The biometric data of a payroll staff person, for example a photo, fingerprint, geographic location, and/or retina scan/image of a payroll staff person can be stored inside a database to authorize and/or authenticate access to system upon successful biometric verification and/or validation.

Example BVS Solution for Geo-Location based access to sensitive and/or critical systems and applications: There is an alternate embodiment of the present invention for the many confidential and critical applications that need to be accessed only from certain or secured buildings. For example systems containing classified or confidential information, court records, defense and military systems, and secure systems with scientific invention data that contain data that is highly valuable and yet needs to be accessible for users granted access based on a users biometric data plus geographic location of the internet/network accessing identification device. This application/solution of BVS ensures access to application data is granted only from predetermined locations and or buildings such that the user of such valuable data needs to be physically present in the specified location in order to gain access to the data via the now secured application. The geo-based access to application and application data offers new thoughts about having jurisdiction over sensitive data. This concept can be further implemented on databases and allow access to data based on jurisdiction. In Geo-Location based BVS authentication, personal must be physically present inside the secured building or location before accessing the application and relevant classified or sensitive data. The user provides biometric data via hand held internet connected device like a smartphone to gain access to sensitive and/or critical applications and relevant data.

Example BVS Solution for Internet Of Things (IOT) secure web: There is an alternate embodiment of the present invention for the IOT industrial web applications that can operate critical machines and electronics that need to be secured. The BVS solution can be used to secure control systems for mechanical and electrical equipment (physical plant and building systems) and prevent malicious actor security breach. For example controlling power grids, water turbines, and securing petrochemical refineries. Such secure web applications, and intra-net applications that control such machines, hydraulics, plants, and systems can be critical to safety and can be hazards which need to be secured. The BVS API can integrate with such secure web applications and enable authentication and verification of users based on run time biometric data.

Example BVS Solution for geo-location and jurisdiction on data: There is an alternate embodiment of the present invention for information technology applications and databases that need to be governed for access based on geographic location of user accessing the data. Using the BVS application geographic boundaries (electronic fences) can be set for determining access to critical data. For example, a specific application and data can be accessed only within the United States of America, or, a government website application can only be accessed in their geographic jurisdiction. In another example, a user wants to limit the use of a bank application to specific cities. The BVS can be used to set geographic boundaries for secure and sensitive data and to enforce jurisdiction over data and databases. Hence the BVS can enable government law enforcement to have jurisdiction over data and make information technology safe. Because information technology is a part of every day activity BVS can address very big and most important problems concerning digital security.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1. A software Biometric Verification Application/System for verifying a personal identity of an user of an identity secured electronic system comprising software enabling a software event triggered real-time biometric identity validation to enable the validation/re-validation of said user's personal identity during said user's use of said identity secured electronic system enabling a validation/re-validation software event during said user's use of said identity secured electronic system to verify an identity of said user and the issue of a security alert notice and notice of a failed biometric identity validation to said identity secured electronic system to enable revalidation by said identity secured electronic system whenever said biometric identity validation fails to validate/re-validate said user's personal identity.

2. The software application of claim 1, further comprising software enabling a determination of a cash transaction amount software event trigger requiring biometric identity validation during said user's use of an electronic system.

3. The software application of claim 1, further comprising software enabling a determination of an application interaction software event trigger requiring biometric identity validation for an interaction by said user's use of an electronic system.

4. The software application of claim 1, further comprising software enabling a determination of a geographic location software event trigger requiring biometric identity validation during said user's use of an electronic system.

5. The software application of claim 1, further comprising software enabling a determination of a cash transaction amount software event trigger requiring biometric identity validation during said user's use of an electronic system, and software enabling a determination of an application interaction software event trigger requiring biometric identity validation for an interaction by said user's use of an electronic system.

6. The software application of claim 1, further comprising software enabling a determination of a cash transaction amount software event trigger requiring biometric identity validation during said user's use of an electronic system, and software enabling a determination of a geographic location software event trigger requiring biometric identity validation during said user's use of an electronic system.

7. The software application of claim 1, further comprising software enabling a determination of a cash transaction amount software event trigger requiring biometric identity validation during said user's use of an electronic system, and software enabling a determination of an application interaction software event trigger requiring biometric identity validation for an interaction by said user's use of an electronic system, and software enabling a determination of a geographic location software event trigger requiring biometric identity validation during said user's use of an electronic system.

8. A software Biometric Verification Application/System for verifying a personal identity of an user of an identity secured electronic system comprising software enabling a software event triggered real-time biometric identity validation to enable the validation/re-validation of said user's personal identity during said user's use of said identity secured electronic system enabling a validation/re-validation software event during said user's use of said identity secured electronic system to verify an identity of said user and the issue of a security alert notice and notice of a failed biometric identity validation to said identity secured electronic system to enable revalidation by said identity secured electronic system whenever said biometric identity validation fails to validate/re-validate said user's personal identity, further comprising software enabling a current geographic location of a user to be validated/re-validated using a current geographic location of said user and the issue of a security alert notice and notice of a failed current geographic location validation to said identity secured electronic system to enable re-validation by said identity secured electronic system whenever said current geographic location validation fails to validate/re-validate said user's current geographic location.

9. The software application of claim 8, further comprising software enabling a determination of a cash transaction amount software event trigger requiring biometric identity validation during said user's use of an electronic system.

10. The software application of claim 8, further comprising software enabling a determination of an application interaction software event trigger requiring biometric identity validation for an interaction by said user's use of an electronic system.

11. The software application of claim 8, further comprising software enabling a determination of a geographic location software event trigger requiring biometric identity validation during said user's use of an electronic system.

12. The software application of claim 8, further comprising software enabling a determination of a cash transaction amount software event trigger requiring biometric identity validation during said user's use of an electronic system, and software enabling a determination of an application interaction software event trigger requiring biometric identity validation for an interaction by said user's use of an electronic system.

13. The software application of claim 8, further comprising software enabling a determination of a cash transaction amount software event trigger requiring biometric identity validation during said user's use of an electronic system, and software enabling a determination of a geographic location software event trigger requiring biometric identity validation during said user's use of an electronic system.

14. The software application of claim 8, further comprising software enabling a determination of a cash transaction amount software event trigger requiring biometric identity validation during said user's use of an electronic system, and software enabling a determination of an application interaction software event trigger requiring biometric identity validation for an interaction by said user's use of an electronic system, and software enabling a determination of a geographic location software event trigger requiring biometric identity validation during said user's use of an electronic system.
